(19) United States
(12) Patent Application Publication
(10) Pub. No.: US 2017/0064801 A1
(43) Pub. Date: Mar. 2, 2017

(54) Device for Monitoring the Alignment of a Laser Beam, and EUV Radiation Generating Apparatus having such a Device

(71) Applicant: TRUMPF Laser- und Systemtechnik GmbH, Ditzingen (DE)

(72) Inventors: Martin Lambert, Korb (DE); Andreas Enzmann, Villingen-Schwenningen (DE)

(21) Appl. No.: 15/347,956

(22) Filed: Nov. 10, 2016

Related U.S. Application Data
(63) Continuation of application No. PCT/EP2014/059742, filed on May 13, 2014.

(51) Int. Cl. H05G 2/00; B23K 26/12; B23K 26/70; B23K 26/04

(52) U.S. Cl. CPC H05G 2/008; B23K 26/043; B23K 26/1224; B23K 26/70

(57) ABSTRACT

This disclosure relates to a device for monitoring the alignment of a laser beam, comprising: a detector having an opening for passage of the laser beam, at least two temperature sensors which are mounted on the detector, and a temperature monitoring device which is connected to the at least two temperature sensors, for monitoring the alignment of the laser beam relative to the opening. The at least two temperature sensors have a temperature-dependent resistance which either increases as the temperature increases or decreases as the temperature increases, and the at least two temperature sensors are connected in series with the temperature monitoring device. This disclosure relates also to an EUV radiation generating apparatus which has at least one device as described above for monitoring the alignment of a laser beam.

### CROSS-REFERENCE TO RELATED APPLICATION

This application is a continuation of and claims priority under 35 U.S.C. §120 to PCT Application No. PCT/EP2014/059742 filed on May 13, 2014. The entire contents of this priority application are incorporated herein by reference.

### TECHNICAL FIELD

The present disclosure relates to a device for monitoring the alignment of a laser beam, the device including: a detector having an opening for passage of the laser beam, at least two temperature sensors which are mounted on the detector, and a temperature monitoring device which is connected to the at least two temperature sensors, for monitoring the alignment of the laser beam relative to the opening. The disclosure relates also to an EUV radiation generating apparatus having at least one such device.

### BACKGROUND

DE 10 2011 005 775 B4 of the applicant describes a detector for determining an alignment of a laser beam with respect to an axis of a predetermined beam path of the laser beam in a laser processing machine. The detector has a plurality of plate-like detector elements which are arranged around the axis for converting impinging laser energy at least partially into heat. The detector elements have recesses which together form, in a projection in the direction of the axis, a circular opening for passage of the laser beam. The detector elements are thermally insulated from one another and can each have a temperature sensor which is connected to a temperature sensor device which determines temperature differences between the detector elements. On the basis of the temperature differences, the alignment of the laser beam can be determined and, if necessary, corrected, such that the axis of the laser beam always coincides with the axis of the detector.

### SUMMARY

It has been shown that, when using laser beams with high laser powers and short pulse durations, the above-described detector may react too slowly, such that the temperature sensors do not respond in good time if there is a misalignment of the laser beam relative to the opening. If an incorrect alignment of the laser beam is recognized too late, the detector can be damaged by the laser beam, for example by local melting of the material thereof. An undetected incorrect alignment of the laser beam can also lead to damage to components located downstream in the beam path or possibly to injury to people or operators of the system in which the laser beam is being used.

An object underlying the implementations described herein is to provide a device for monitoring the alignment of a laser beam and an EUV radiation generating apparatus having at least one such device, with which reliable monitoring of the alignment of a laser beam is possible.

The object can be achieved by a device of the type described herein, wherein the at least two temperature sensors have a temperature-dependent resistance that either increases as the temperature increases or decreases as the temperature increases, and wherein the at least two temperature sensors are connected in series with the temperature monitoring device. Within the meaning of this application, a laser beam is generally understood as being a high-energy beam, that is to say, for example, also a plasma beam, the alignment of which can likewise be monitored in the manner described above.

The at least two (e.g., two three, four or more) temperature sensors of the detector are connected together in series, and all the temperature sensors connected in series have a resistance whose dependence on the temperature is positive (e.g., positive temperature coefficient, PTC, thermistors) or negative (e.g., negative temperature coefficient, NTC, thermistors). Therefore, energy input into the detector (e.g., due to a laser beam), results in either an increase or a reduction of the resistances of the temperature sensors. Due to the series connection between the temperature sensors, this increase or reduction of the resistances is measured in total across the temperature sensors. Thus, the sensitivity of the detector (or that of the device as a whole) to sudden temperature rises increases significantly. The temperature monitoring device can include a switching arrangement or a switching circuit that is connected in an electrically conductive manner to the temperature sensors connected in series.

In some cases, the temperature monitoring device can generate a binary signal based on the operation of the detector. For example, the temperature monitoring device can indicate when the temperature of the detector has exceeded a predetermined temperature threshold value that represents a shift between a “temperature in order” state (e.g., a “normal temperature” state or an “acceptable temperature” state) and “temperature not in order” state (e.g., an “abnormal temperature” state or an “unacceptable temperature” state). It has been shown that conventional temperature switches on the detector, which are to perform this function, do not respond quickly enough to a change in temperature. Because the temperature sensors are connected in series, the location in the peripheral direction at which the laser beam strikes the detector is not important for the detection of the temperature rise, and the sensitivity of the detection is increased by the series connection.

If the laser beam is not aligned incorrectly, the direction of the beam axis of the laser beam coincides with the axis of the detector, which runs centrally through the opening of the detector. The detector, or the opening of the detector, can form a diaphragm or an aperture for the laser beam such that, even in the case of correct alignment, a small portion of the laser radiation strikes the region of the periphery of the opening and is screened by the detector or by the diaphragm. In this case, however, the total resistance of the temperature sensors connected in series is low. The total resistance increases significantly, however, in the case of a misalignment of the laser beam, where the laser beam is offset or at an angle relative to the axis of the detector, because this is associated with an increased heat input into the detector.

In some embodiments, the temperature sensors are in the form of PTC resistors. Such temperature sensors, which are also referred to as PTC thermistors, have a high sensitivity to rapid temperature rises and are therefore particularly suitable for the present application. A further advantage of the use of PTC resistors is that an interruption in the series connection or the burning out of a PTC resistor leads to a sudden rise in the resistance measured by the temperature monitoring device and thus to the same result as in the case of a temperature rise of the detector. Because the resistance becomes almost infinitely great in the case of a break and thus greater than the increase in the resistance of the temperature sensors that is to be expected in the case of a heat input, the temperature monitoring device can also be used to detect a fault in the form of a burnt-out circuit or PTC resistor. It will be appreciated that, as an alternative, it is also possible to use NTC resistors or other components having a highly temperature-dependent resistance as temperature sensors. Because the change in the resistance is proportional to the power of the laser beam incident upon the detector, the energy input into the detector can also be determined on the basis of the change in the resistance.

In further embodiments, the detector has a base body that encloses the opening annularly and into which the temperature sensors are integrated. Within the meaning of this application, integration of the temperature sensors is also understood as meaning the mounting thereof on an outside of the base body, provided that the temperature sensors are in flat contact therewith. Integrating the temperature sensors into the base body enables the temperature sensors to respond rapidly to changes in temperature. The base body is preferably in one piece and has openings or bores for receiving the temperature sensors. The base body can optionally also be in multi-part form.

In an advantageous further development, the base body is formed of metal, in particular of copper, or of another material that has a particularly high thermal conduction coefficient (e.g., silicon carbide Si/SiC) optionally with added carbon (e.g., diamond). As a result of the high thermal conduction coefficient, or the low heat resistance, of the base body, the heat introduced into the detector by the laser beam can be conveyed rapidly to the temperature sensors. In addition to thermal conduction, the base body generally performs the further function of forming the edge of the opening through which the laser beam passes. In order to prevent the base body from melting immediately upon contact with the laser beam, the base body can be made of a heat-resistant material, which is the case for the materials described above, in particular for copper and Si/SiC.

In a further development, an absorber is mounted on the base body, typically on the side of the base body at which the laser beam strikes the base body or the detector. The absorber can be, for example, an insert that has been brought into flat contact with the base body (e.g., by inserting or pressing the absorber into the base body). The absorber material of the absorber can be, for example, hard anodized aluminum or another material having high absorption for radiation at the wavelength of the laser beam. The absorber material absorbs the heat of the impinging laser beam, which is dissipated via the base body.

In another further development, the detector has a cooling body that is connected to the annular base body via a thermal bridge. The typically plate-like base body is connected to the cooling body or is fixed thereto. Preferably, the cooling body is connected in a thermally conductive manner to the annular base body only via a thermal bridge, that is to say via a web (e.g., a peripheral web). The cooling body is otherwise thermally insulated with respect to the base body, that is to say it does not abut the base body, or a gap is formed between the base body and the cooling body which is bridged only by the thermal bridge. The thermal bridge, or the web-like connection, allows the comparatively low thermal output that is introduced into the detector acting as a diaphragm to be dissipated in normal operation, that is to say when the laser beam is aligned correctly. If a laser beam that is not adjusted correctly strikes the base body, the base body is heated and the temperature sensors mounted thereon quickly, because the additional heat input cannot be dissipated quickly enough via the thermal bridge. The sensitivity of the device for detecting an incorrect alignment of the laser beam can accordingly be increased by means of the thermal bridge.

In an advantageous further development, the cooling body has at least one cooling channel through which there flows a cooling medium (e.g., cooling water). It is advantageous not to guide the cooling medium through the base body itself, in order to prevent the cooling medium from being able to pass out of the cooling channel into the beam path of the laser beam or into the surroundings if the material of the base body should melt.

In further embodiments, the temperature sensors are distributed evenly over the periphery of the opening. In this case, the angles that adjacent temperature sensors enclose between one another in the peripheral direction of the opening are equal, that is to say the angle between two temperature sensors is: 360°/n, where n denotes the number of temperature sensors. Such an even or regular arrangement of the temperature sensors is advantageous because, irrespective of the position in the peripheral direction at which the laser beam strikes the detector in the case of a maladjustment, a temperature sensor is thus typically always arranged in the vicinity.

In some embodiments, the temperature monitoring device has at least one switching element. Each switching element is designed to switch from a first switching state into a second switching state when a predetermined switching threshold, which is assigned to a temperature threshold value or optionally to a threshold value of the change in the temperature over time, is exceeded. When the switching threshold, which can correspond, for example, to a predetermined voltage drop at the switching element, is exceeded, the switching element switches from the first switching state (e.g. a “temperature in order” state) into the second switching state (e.g. a “temperature not in order” state). The voltage drop at the switching element is typically influenced by the total resistance of the temperature sensors. Instead of a threshold value of the temperature, a change in the temperature over time, that is to say a temperature gradient, can optionally be used as the switching threshold at which switching from a first switching state into a second switching state takes place. When the switching threshold is exceeded, the laser source generating the laser can optionally be switched off automatically.

In a further development of these embodiments, the temperature monitoring device has a first switching element and a second switching element that are each designed to switch from a first switching state into a second switching state when different switching thresholds, which are assigned to different temperature threshold values, are exceeded. In this case, when a first switching threshold, which is exceeded at a first, lower temperature, is exceeded, a warning, for example, can be given to an operator. Subsequently, a counter-measure is initiated when the second switching threshold is exceeded. The counter-measure can include switching off the laser source generating the laser beam. The first switching element and the second switching element can in particular be connected in parallel with one another.

In further embodiments, the at least one switching element is in the form of a Zener diode. A Zener diode blocks the passage or a current flow when a switching threshold (in the form of a breakdown voltage) is reached or fallen below. The breakdown voltage is dependent on the type of Zener diode used and can be, for example, 2.7 V, 5.6 V or 8.2 V. If a switching element in the form of a Zener diode is connected in series with a plurality of temperature sensors in the form of PTC resistors, the voltage falling at the temperature sensors increases as the temperature increases, whereby, at a given supply voltage, the voltage falling at the Zener diode decreases. If the voltage falling at the Zener diode falls below the breakdown voltage, the Zener diode blocks the current flow, such that the corresponding branch of the switching arrangement is interrupted. If two Zener diodes with different breakdown voltages are connected in parallel in the switching arrangement of the temperature monitoring device, a first Zener diode having a higher breakdown voltage can serve to switch at a first temperature of the detector or of the temperature sensors and, for example, emit a warning. The second Zener diode having the lower breakdown voltage can serve to switch at a second, higher temperature and indicate to the operator that a counter-measure should be initiated, for example by switching off the laser source for generating the laser beam. It will be appreciated that electronic switching elements other than Zener diodes can also be used in the temperature monitoring device, for example relays or the like.

In further embodiments, the temperature monitoring device includes a device for adjusting the at least one temperature threshold value that is assigned to the at least one switching threshold. As has been described above, when a switching element in the form of a Zener diode is used, the breakdown voltage is dependent on the diode type used and is accordingly fixed. Nevertheless, in order to vary the temperature threshold value at which the switch in the form of the Zener diode switches, an adjustable voltage divider, for example in the form of a potentiometer, can be used. The potentiometer is typically connected in series with the temperature sensors, such that an adjustable resistance is provided. Thus the voltage that falls at the potentiometer is added to the voltage that falls at the temperature sensors. The voltage falling at the Zener diode, and accordingly also the temperature threshold value at which the Zener diode switches, change accordingly.

In further embodiments, the at least one switching device is connected in series with the temperature sensors. In this manner, the voltage falling at the switching device decreases or increases directly (or proportionally) with the resistance of the temperature sensors, which increases or falls in dependence on the temperature. If a constant supply voltage is applied to the series connection of the temperature sensors and of the switching element and the series connection of the temperature sensors is interrupted (e.g., because of a burnt-out temperature sensor), the voltage falling at the switching element immediately falls to 0 V, and this fault is also detected. Thus, the reliability of the temperature monitoring is increased further.

A further aspect relates to an EUV radiation generating apparatus, including: a vacuum chamber having a vacuum environment in which a target material can be arranged in a target region for generating EUV radiation, a beam guiding device for guiding a laser beam into the target region, and at least one device as described above for monitoring the alignment of the laser beam guided by the beam guiding device. The detector of the device, more precisely the opening through which the laser beam passes, can in particular serve as a diaphragm arranged in the beam guiding device. The alignment of the laser beam in the diaphragm opening, or the temperature of the detector serving as the diaphragm, can be monitored in order to prevent damage to the diaphragm and/or to further components arranged in the beam path after the diaphragm. It will be appreciated that the device described above can advantageously be used not only in an EUV radiation generating apparatus but also in other apparatuses, for example in laser processing machines or the like, in particular when a pulsed laser beam with high laser power is used therein.

In some embodiments, the EUV radiation generating apparatus includes a laser beam generating device for generating the laser beam, and the device is designed to switch off the laser beam generating device when a temperature threshold value is exceeded. As has been described above, it is advantageous, when a predetermined temperature threshold value (e.g., 50° C.) is exceeded, to switch off the laser source in order to prevent damage to the detector or the diaphragm and/or to further components of the EUV radiation generating apparatus. For this purpose, a signal (e.g., an electrical signal) can be transmitted by the device for monitoring the alignment of the laser beam to the laser beam generating device.

Further advantages will become apparent from the description and the drawings. Likewise, the features mentioned above and described below can be used each on its own or in arbitrary combinations. The embodiments shown and described are not to be interpreted as being an exhaustive list, but are instead of exemplary nature for illustrating the invention.

### DESCRIPTION OF DRAWINGS

FIG. 1 is a schematic representation of an EUV radiation generating apparatus having a detector.

FIG. 2 is a circuit diagram of a temperature monitoring device for monitoring the temperature of the detector shown in FIG. 1.

FIG. 3 is a detailed representation of an embodiment of the detector of FIG. 1.

### DETAILED DESCRIPTION

In the following description of the drawings, identical reference numerals are used for components that are the same or have the same function.

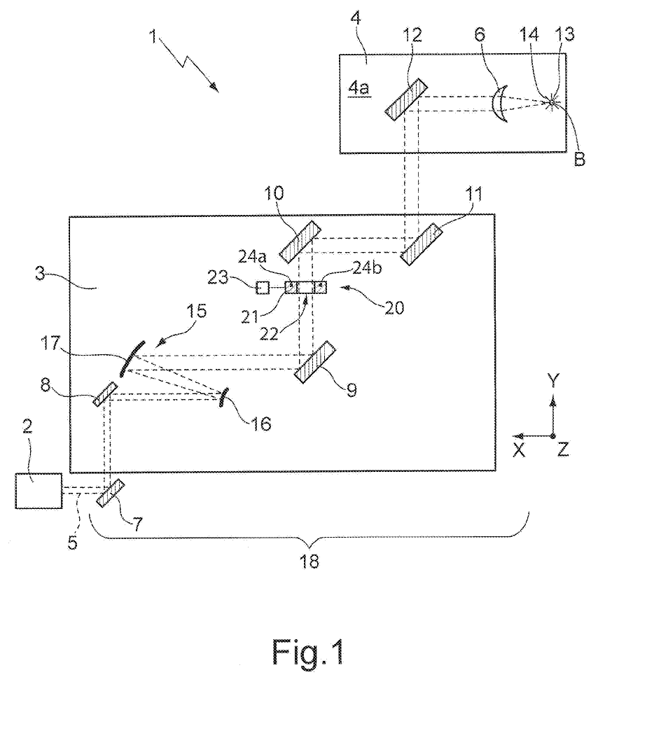

FIG. 1 shows an EUV radiation generating apparatus 1 which has a laser beam generating device 2 (also called a driver laser device), a beam guiding chamber 3, and a vacuum chamber 4. In a vacuum environment 4a formed in the vacuum chamber 4 there is arranged a focusing device in the form of a focusing lens 6 for focusing a CO₂ laser beam 5 in a target region B. The EUV radiation generating apparatus 1 shown in FIG. 1 corresponds substantially to the structure as described in U.S. Publication No. 2011/0140008 A1, which is incorporated herein by reference in its entirety.

The laser beam generating device 2 includes a CO₂ beam source and a plurality of amplifiers for generating a laser beam 5 with high radiation power (>1 kW). For a detailed description of examples of possible configurations of the laser beam generating device 2, reference is made to U.S. Publication No. 2011/0140008 A1. From the laser beam generating device 2, the laser beam 5 is deflected via a plurality of deflecting mirrors 7 to 11 of the beam guiding chamber 3 and a further deflecting mirror 12 in the vacuum chamber 4 onto the focusing lens 6, which focuses the laser beam 5 in the target region B in which tin is arranged as target material 13.

The target material 13 is struck by the focused laser beam 5 and thereby converted into a plasma state, which serves to generate EUV radiation 14. The target material is supplied to the target region B by means of a supply device (not shown), which guides the target material along a predetermined path which crosses the target region B. For details of the supply of the target material, reference is likewise made to U.S. Publication No. 2011/0140008 A1.

In a beam guiding space of the beam guiding chamber 3 there is provided a device 15 for enlarging the beam diameter of the laser beam 5, which has a first off-axis parabolic mirror 16 with a first, convex reflecting surface and a second off-axis parabolic mirror 17 with a second, concave reflecting surface. The reflecting surfaces of an off-axis parabolic mirror 16, 17 in each case form the off-axis segments of an elliptic paraboloid. The term “off-axis” means that the reflecting surfaces do not contain the axis of rotation of the paraboloid (and hence also not the vertex of the paraboloid).

The optical elements 7 to 11, 16, 17, 12, 6 together form a beam guiding device 18 for guiding the laser beam 5 into the target region B. For monitoring the beam path of the laser beam 5 there is arranged in the beam guiding space of the beam guiding chamber 3 a device 20 for monitoring the alignment of the laser beam 5. The device 20 includes a detector 21 having an opening 22 for the passage of the laser beam 5, and a temperature monitoring device 23. In the example shown, four temperature sensors 24a-d are integrated into the detector 21, of which two are shown in FIG. 1. The temperature sensors 24a-d are electrically connected to the temperature monitoring device 23 in order to monitor the alignment of the laser beam 5 relative to the opening 22. The four temperature sensors 24a-d are in the form of PTC resistors, for example PT100 or PT500, and therefore have a temperature-dependent resistance which increases as the temperature increases.

When the laser beam 5 is aligned correctly, the laser beam axis coincides with the central axis, or the mid-point, of the circular opening 22, such that the laser beam 5 strikes the detector 21 acting as a diaphragm only in a narrow edge region with low radiation power. If, on the other hand, the laser beam 5 is maladjusted, that is to say at an angle or displaced relative to the central axis of the detector 21, the proportion of the radiation power which strikes the detector 21 increases. The more pronounced the misalignment, the more the temperature of the detector 21 increases. Accordingly, the alignment of the laser beam 5 can be monitored on the basis of the temperature of the detector 21 monitored by means of the temperature sensors 24a-d.

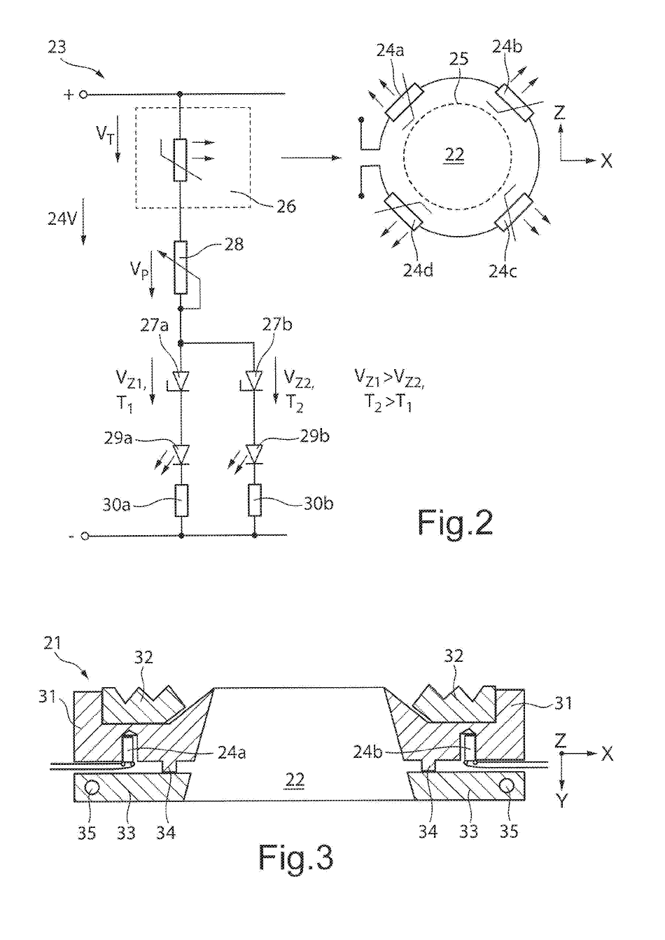

FIG. 2 shows a circuit diagram of the temperature monitoring device 23 and of the temperature sensors 24a-d. As shown in FIG. 2, the four temperature sensors 24a-d are connected in series in order to be able to detect the temperature rise of the detector 21 as quickly as possible. As can likewise be seen in FIG. 2, the temperature sensors 24a-d are distributed evenly along the periphery of the opening 22, that is to say adjacent temperature sensors 24a-d are aligned at an angle of 90° to one another in the peripheral direction. In the example shown, the temperature sensors 24a-d each have a resistance of approximately 500 KΩ at room temperature, such that the total resistance 26 of the series connection of the temperature sensors 24a-d shown on the right in FIG. 2 at room temperature is approximately 2 MΩ.

The temperature sensors 24a-d, or their total or equivalent resistor 26, are connected in series in the temperature monitoring device 23 with a parallel circuit including two switching elements in the form of Zener diodes 27a, 27b. In a respective branch, an LED 29a, 29b and a suitably dimensioned series resistor 30a, 30b is connected in series with the Zener diode 27a, 27b. A potentiometer is connected in series with the temperature sensors 24a-d. The potentiometer serves as a device 28 for changing temperature threshold values T₁, T₂, as will be described in greater detail below.

When the laser beam 5 is aligned correctly, the detector 21 is heated only insignificantly, that is to say the temperature of the detector 21 is only slightly higher than room temperature. The temperature monitoring device 23 is operated with a constant voltage of 24 V, and the series resistors 24a-d are matched to the resistance values of the temperature sensors 24a-d in such a manner that, when the laser beam 5 is aligned correctly, a sufficiently great voltage falls at the two LEDs 29a, 29b to illuminate them. Through the two active LEDs 29a, 29b, an operator can recognize that the laser beam 5 is aligned correctly.

If the temperature of the detector 21 increases, the temperature sensors 24a-d are heated and their resistance increases. The voltage VT falling at the total or equivalent resistor 26 also increases accordingly. If the voltage VT falling at the temperature sensors 24a-d becomes too great as a result of the increase in the temperature of the detector 21, the voltage falling at the two Zener diodes serving as switching elements 27a, 27b falls. If the voltage at the Zener diodes 27a, 27b falls below the breakdown voltage V_{Z1}, V_{Z2} (which in the example shown is V_{Z1}=5.6 V in the case of the first Zener diode 27a and V_{Z2}=2.7 V in the case of the second Zener diode 27b), the respective Zener diode 27a, 27b blocks, that is to say the corresponding branch of the switching circuit is open. Thus, a voltage no longer falls at the associated LED 29a, 29b and it is no longer illuminated.

As has been described above, the breakdown voltages V_{Z1}, V_{Z2} of the two Zener diodes 27a, 27b are different in the example shown, such that they are reached at different temperature threshold values T₁, T₂. The first Zener diode 27a, which has a greater breakdown voltage V_{Z1}, is thereby switched at a smaller temperature threshold value T₁ from a first switching state, in which the Zener diode 27a does not block, to a second switching state, in which the Zener diode 27a blocks the current flow. Correspondingly, the second Zener diode 27b only switches from the first switching state into the second switching state and blocks the current flow to the associated second LED 29b at a higher temperature threshold value T₂>T₁.

The first Zener diode 27a serving as a first switching element can accordingly be used to inform the operator that the temperature at the detector 21 is unusually high and, for example, has exceeded a temperature threshold value T₁ of 35° C. If the temperature of the detector 21 continues to increase and exceeds the second temperature threshold value T₂, which can be, for example, 50° C., the second Zener diode 27b blocks and the second LED 29b is no longer illuminated, which indicates to an operator that the laser beam generating device 2 should be switched off or the alignment of the laser beam 5 should be suitably corrected.

It will be appreciated that, when the second temperature threshold value T₂ is exceeded, an acoustic notification can be given as an alternative or in addition to a visual notification. Alternatively or in addition, the device 20, or the temperature monitoring device 23, can in particular be designed to transmit a signal to the laser beam generating device 2 in order to switch off the laser beam 5 and thus protect the detector 21 and further components arranged in the region of the beam path of the laser beam 5 from damage. By means of the series connection of the temperature sensors 24a-d with the switching elements 27a, 27b, the switching circuit of the temperature monitoring device 23 is also opened in the case of an interruption, for example if one of the temperature sensors 24a-d burns out, such that this fault can also be detected.

In order to adjust the temperature threshold values T₁, T₂ at which the Zener diodes serving as switching elements 27a, 27b switch from the first switching state into the second switching state, there is arranged in the temperature monitoring device 23 an adjustable device in the form of a potentiometer 28. The resistance of the potentiometer 28, and thus the voltage V_{P} falling thereat, can be adjusted by an operator. Because the voltage that falls at the Zener diodes 27a, 27b is reduced by the amount of the voltage V_{P} that falls at the potentiometer 28, the temperature threshold values T₁, T₂ at which the switching elements 27a, 27b switch from the first switching state into the second switching state can be adjusted by adjusting the voltage V_{P}. The voltage V_{P} can be adjusted on the basis of the temperature-dependent characteristic curves of the temperature sensors 24a-d in the form of PTC resistors. If the two temperature threshold values T₁, T₂ are to be adjusted independently of one another, it is possible to use two potentiometers which are arranged in a respective branch of a Zener diode 27a, 27b.

There are several possibilities for the configuration of the detector 21, one of which is shown by way of example in FIG. 3. As shown in FIG. 3, the detector 21 has a base body 31 with an annular inside geometry enclosing the opening 22, which is circular in a plan view of the detector 21. The base body 31 is made of a material having high thermal conductivity. Suitable materials for the base body 31 are in particular metals, for example copper. The temperature sensors 24a, 24b are integrated into the base body 31; in the example shown, they are mounted in cavities in the form of bores and are in flat contact with the base body 31 or are embedded by means of a heat conducting paste or a heat conducting adhesive in order to produce a good heat transfer. In a region of the base body 31 facing the incident laser beam 5 there is mounted an absorber 32 which is likewise annular and is made of an absorber material. In the example shown, the absorber material is hard anodized aluminum. Due to the hard layer, the underlying aluminum is also “sheathed” against melting, such that peaks in the absorber material are maintained for longer. The absorption is also increased as a result of the hard anodization. Depressions are formed in the absorber 32, the radial cross-section of which depressions in each case has the shape of an acute triangle in order to achieve good absorption of the laser radiation 5. It will be appreciated that materials other than those described here can be used for the base body 31 and for the absorber 32.

The base body 31 is connected to a cooling body 33 made of aluminum via a thermal bridge 34 which is likewise annular and is in the form of a web. Otherwise, the cooling body 33 is separated from the base body 31 by a gap and is thus thermally insulated. When the laser beam 5 is aligned correctly, a comparatively small thermal load is generated by the laser radiation in the edge region of the laser beam 5, which is cropped by the detector 21 acting as a diaphragm. This thermal load is dissipated via the thermal bridge 34 provided in the vicinity of the periphery of the opening 22.

When the laser beam 5 is aligned incorrectly, the thermal load on the base body 31 increases sharply, such that it can no longer be dissipated sufficiently via the thermal bridge 34. This leads to heating of the base body 31 and thus also of the temperature sensors 24a-d integrated therein. The temperature sensors 24a-d may also be mounted on the outside of the base body 31, provided there is flat contact and thus good heat transfer.

In the plate-like cooling body 35 there is provided a cooling channel 35 through which there flows a cooling medium, for example cooling water. The base body 31 arranged in front of the cooling body 33 in the beam direction of the laser beam 5 absorbs the impinging laser radiation and prevents the detector 21 from melting through to the cooling channel 35, such that the cooling medium can be prevented from escaping into the beam path of the laser beam 5 or into the surroundings.

In summary, temperature rises caused by an incorrect alignment of the laser beam 5 can be detected quickly in the manner described above, and the detector 21 and further components can thus be protected from damage by the high-energy laser radiation. The location at which the incorrectly aligned laser beam 5 strikes the detector 21 is virtually irrelevant on account of the rapid heat transfer, or the high thermal conduction coefficient of the base body 31, and a sufficiently large number of temperature sensors 24a-d. Instead of temperature sensors 24a-d in the form of PTC resistors, it is also possible to use temperature sensors in the form of NTC resistors or in the form of other electronic components whose resistance is highly dependent on the temperature or which have at least one other temperature-dependent property which can be detected by the temperature monitoring device 23. The device 20 can of course also be used in other optical devices or systems in which a high-energy laser beam is used, for example in a laser processing machine or the like.

A number of embodiments have been described. Nevertheless, it will be understood that various modifications may be made without departing from the spirit and scope of the invention. Accordingly, other embodiments are within the scope of the following claims.

What is claimed is:

1. A system for monitoring the alignment of a laser beam, the system comprising:
a detector defining an opening for passage of the laser beam;
a plurality of temperature sensors mounted on the detector; and
a temperature monitoring device connected to the plurality of temperature sensors, wherein the temperature monitoring device is configured to monitor the alignment of the laser beam relative to the opening,
wherein each temperature sensor of the plurality of temperature sensors has a temperature-dependent resistance that either increases as a temperature of the temperature sensor increases or decreases as the temperature of the temperature sensor increases, and
wherein the plurality of temperature sensors are connected in series with the temperature monitoring device.

2. The system according to claim 1, wherein the plurality of temperature sensors comprise one or more PTC resistors.

3. The system according to claim 1, wherein the detector comprises a base body surrounding the opening annularly, and wherein the plurality of temperature sensors are integrated with the base body.

4. The system according to claim 3, wherein the base body is composed of metal.

5. The system according to claim 3, further comprising an absorber mounted on the base body.

6. The system according to claim 3, wherein the detector comprises a cooling body connected to the base body via a thermal bridge.

7. The system according to claim 6, wherein the cooling body defines at least one cooling channel, and wherein the at least one cooling channel is configured to receive a cooling medium.

8. The system according to claim 1, wherein the plurality of temperature sensors is distributed evenly about a periphery of the opening.

9. The system according to claim 1, wherein the temperature monitoring device comprises a first switching element, wherein the first switching element is configured to switch from a respective first switching state of the first switching element into a second switching state of the first switching element when a first switching threshold is exceeded, wherein the first switching threshold corresponds to a first temperature threshold value.

10. The system according to claim 9, wherein the temperature monitoring device further comprises a second switching element, wherein the second switching element is configured to switch from a first switching state of the second switching element into a second switching state of the second switching element when a second switching threshold is exceeded, wherein the second switching threshold corresponds to a second temperature threshold value, and wherein the first temperature threshold value is different than the second temperature threshold value.

11. The system according to claim 10, wherein the first switching element and the second switching element each comprise a respective Zener diode.

12. The system according to claim 10, wherein the temperature monitoring device further comprises an adjustment device configured to adjust at least one of the first temperature threshold value or the second temperature threshold value.

13. The system according to claim 10, wherein at least one of the first switching element and the second switching element is connected in series with the plurality of temperature sensors.

14. An EUV radiation generating apparatus, the apparatus comprising:
a vacuum chamber defining a vacuum environment, wherein the vacuum chamber is configured to receive a target material in a target region of the vacuum environment;
a beam guiding device configured to guide a laser beam into the target region to generate EUV radiation; and
a system for monitoring the alignment of a laser beam, the system comprising:
a detector defining an opening for passage of the laser beam;
a plurality of temperature sensors mounted on the detector; and
a temperature monitoring device connected to the plurality of temperature sensors, wherein the temperature monitoring device is configured to monitor the alignment of the laser beam relative to the opening,
wherein each temperature sensor of the plurality of temperature sensors has a temperature-dependent resistance that either increases as a temperature of the temperature sensor increases or decreases as the temperature of the temperature sensor increases, and
wherein the plurality of temperature sensors are connected in series with the temperature monitoring device.

15. The EUV radiation generating apparatus according to claim 14, further comprising:
a laser beam generating device configured to generate the laser beam,
wherein the system is configured to switch off the laser beam generating device upon determining that a temperature threshold value is exceeded.
